(19) United States
(12) Patent Application Publication
(10) Pub. No.: US 2026/0018905 A1
(43) Pub. Date: Jan. 15, 2026

(54) METHOD OF OPERATING BATTERY CHARGING CIRCUITS

(71) Applicant: Caterpillar Inc., Peoria, IL (US)

(72) Inventors: Bharadwaj Kaka, Bengaluru (IN); Divakar, Bengaluru (IN); Souvik Das, Bengaluru (IN)

(73) Assignee: Caterpillar Inc., Peoria, IL (US)

(21) Appl. No.: 18/766,712

(22) Filed: Jul. 9, 2024

(51) Int. Cl. H02J 7/00; H02J 7/06

(52) U.S. Cl. CPC H02J 7/00047; H02J 7/06; H02J 2207/20

(57) ABSTRACT

A method of operating a battery charging circuit for charging a battery is described. The method includes controlling the battery charging circuit to operate in a first mode to output a direct current (DC) current at a first voltage less than or equal to a predefined threshold and controlling the battery charging circuit to operate in a second mode to output the DC current at a second voltage greater than the predefined threshold. In the first mode, the AC-to-DC converter is controlled to regulate a DC link voltage across a DC link capacitor and the DC-to-DC converter is configured to output the DC current at the first voltage. In the second mode, the AC-to-DC converter is controlled to output the DC current and the DC-to-DC converter is bypassed to equalize the DC link voltage with the second voltage.

### TECHNICAL FIELD

The present disclosure relates to battery chargers for charging batteries having different voltage levels.

### BACKGROUND

With an increase in demand for electric vehicles, the demand for battery chargers for charging batteries of these electric vehicles has also increased. Such battery chargers usually operate with two power conversion stages including an alternating current (AC) to direct current (DC) converter (i.e., AC-to-DC converter) and a direct current (DC) to direct current (DC) converter (i.e., DC-to-DC converter). The AC-to-DC converter and the DC-to-DC converter include multiple transistors switchable between open and close positions to provide a desired level of DC current for charging the batteries.

However, operating the battery chargers to provide the DC current at higher battery voltage levels may lead to higher power losses and ripples in the DC current provided to the battery. Additionally, when operating at higher battery voltage levels, the duty cycle of the DC-to-DC converter may be increased to meet the high voltage requirements, potentially causing instability in the DC-to-DC converter.

United States Patent Publication Number 20080297123A1 describes methods and apparatuses for concurrently eliminating or substantially reducing two or more switching losses in an inverter switching circuit. It describes reducing multiple types of switching losses under hard switching mode and soft switching mode for active switching devices and diodes.

### SUMMARY OF THE INVENTION

In an aspect, the present disclosure relates to a method of operating a battery charging circuit for charging a battery. The battery charging circuit includes an alternating current (AC) to direct current (DC) converter, a DC link capacitor electrically connected to output terminals of the AC-to-DC converter, and a DC-to-DC converter electrically connected across the DC link capacitor. The method includes controlling the battery charging circuit to operate in a first mode to output a DC current at a first voltage less than or equal to a predefined threshold and controlling the battery charging circuit to operate in a second mode to output the DC current at a second voltage greater than the predefined threshold. In the first mode, the AC-to-DC converter is controlled to regulate a DC link voltage across the DC link capacitor and the DC-to-DC converter is controlled to output the DC current at the first voltage. In the second mode, the AC-to-DC converter is controlled to output the DC current and the DC-to-DC converter is bypassed to equalize the DC link voltage with the second voltage. The second voltage corresponds to a voltage level of the battery.

In another aspect, the present disclosure relates to a system for operating a battery charging circuit for charging a battery. The battery charging circuit includes an alternating current (AC) to direct current (DC) converter, a DC link capacitor electrically connected to output terminals of the AC-to-DC converter, and a DC-to-DC converter electrically connected across the DC link capacitor. The system includes a controller configured to control the battery charging circuit to operate in a first mode to output a DC current at a first voltage less than or equal to a predefined threshold and control the battery charging circuit to operate in a second mode to output the DC current at a second voltage greater than the predefined threshold. In the first mode, the AC-to-DC converter is controlled to regulate a DC link voltage across the DC link capacitor and the DC-to-DC converter is controlled to output the DC current at the first voltage. In the second mode, the AC-to-DC converter is controlled to output the DC current and the DC-to-DC converter is bypassed to equalize the DC link voltage with the second voltage. The second voltage corresponds to a voltage level of the battery.

### BRIEF DESCRIPTION

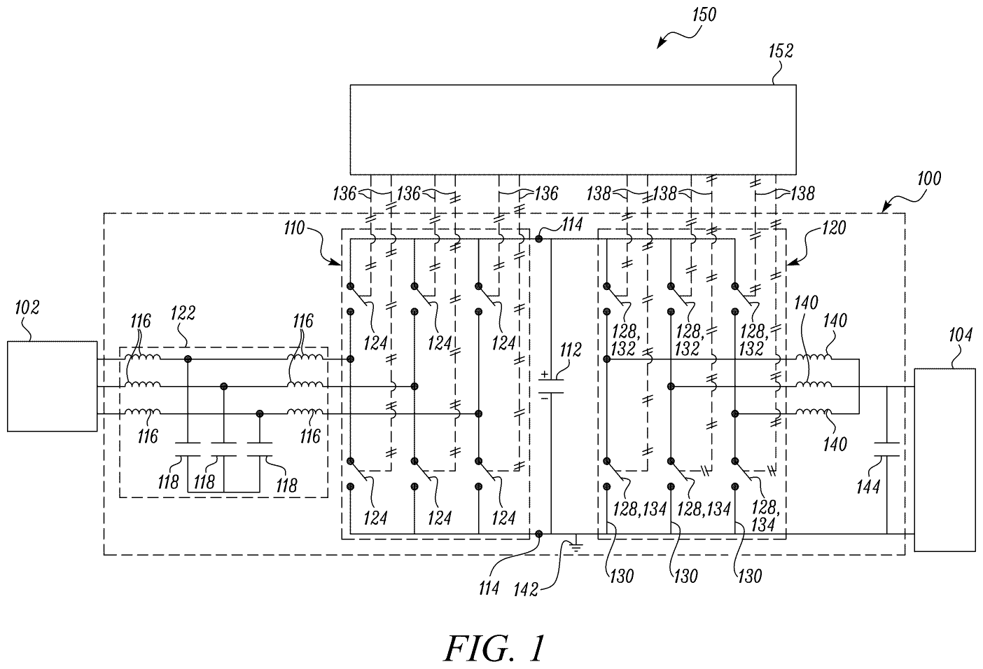

FIG. 1 illustrates a battery charging circuit operating in a first mode, in accordance with an embodiment of the present disclosure;

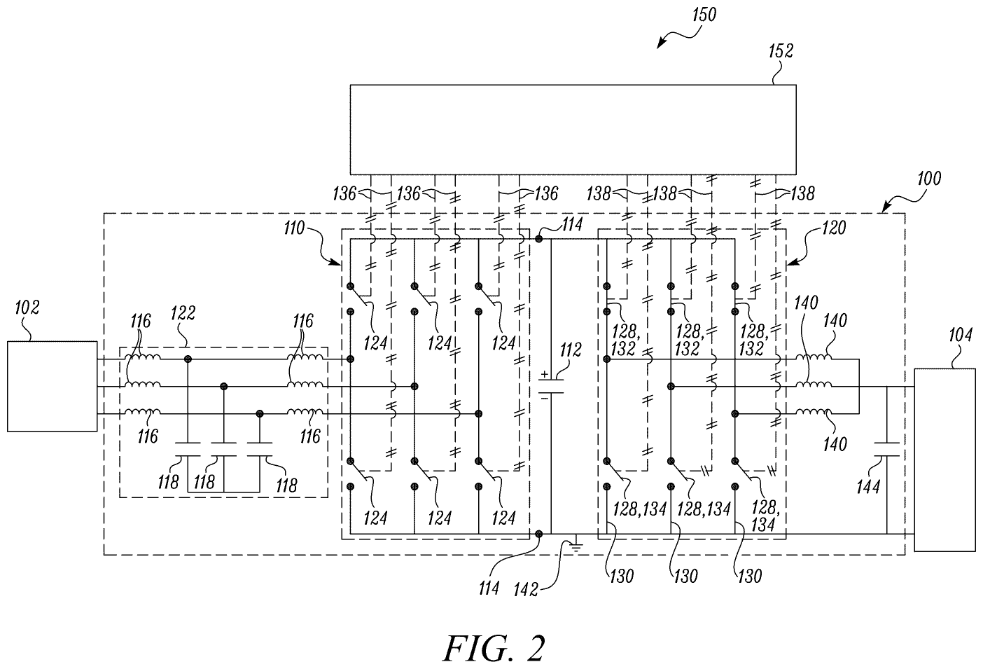

FIG. 2 illustrates the battery charging circuit operating in a second mode, in accordance with an embodiment of the present disclosure; and

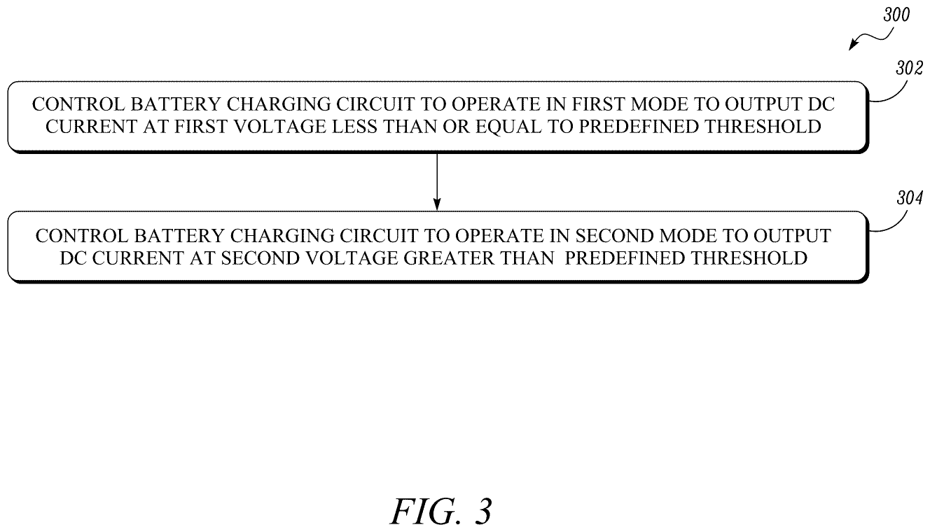

FIG. 3 is an exemplary method for operating the battery charging circuit of FIGS. 1 and 2, in accordance with an embodiment of the present disclosure.

### DETAILED DESCRIPTION

Reference will now be made in detail to specific embodiments or features, examples of which are illustrated in the accompanying drawings. Wherever possible, the same reference numbers will be used throughout the drawings to refer to the same or the like parts.

Referring to FIGS. 1 and 2, a battery charging circuit 100 is described. The battery charging circuit 100 is utilized to charge a battery, for example, a battery 104 of any electrical work machine (not shown). The battery charging circuit 100 may be employed in any battery charger and can be utilized to generate a voltage depending upon the requirements of the battery 104. For example, the voltage of the battery charging circuit 100 may vary between 300 Volts to 1500 Volts depending upon the requirements of the battery 104.

As shown in FIGS. 1 and 2, the battery charging circuit 100 includes an alternating current (AC) to direct current (DC) converter 110 (hereinafter referred to as AC-to-DC converter 110), a direct link (DC) link capacitor 112 electrically connected to output terminals 114 of the AC-to-DC converter 110, and a direct current (DC) to direct current (DC) converter 120 (hereinafter referred to as DC-to-DC converter 120) electrically connected across the DC link capacitor 112.

The battery charging circuit 100 receives an alternating current (AC) at an AC input voltage from an AC source 102, such as a standard AC power grid. The AC-to-DC converter 110 is controlled to convert the AC input voltage received from the AC source 102 into a DC-link voltage across the DC link capacitor 112 and regulate the DC-link voltage. To this end, the AC-to-DC converter 110 may include a plurality of transistors 124 that can be controlled to switch between an open state and a closed state to provide a DC voltage at the output terminals 114. For example, the transistors 124 may correspond to insulated-gate bipolar transistors or any similar transistors known in the art.

The transistors 124 may be switched between the open state and the closed state by varying a duty cycle of a first pulse width modulation (PWM) signal 136 provided to the transistors 124. For example, an open state of the transistor 124 may correspond to a state during which the transistor 124 restricts any flow of current and the closed state may correspond to a state during which the transistor 124 enables the flow of current. By varying the duty cycle of the first PWM signal 136 provided to the transistors 124, the flow of current through the transistors 124 can be controlled, thereby controlling and regulating a level of the DC voltage at the output terminals 114 of the AC-to-DC converter 110. For example, the AC input voltage may correspond to 660 Volts and the DC voltage at the output terminals 114 of the AC-to-DC converter 110 may correspond to 1500 Volts. It would be appreciated that the functioning of the AC-to-DC converter 110 is well known in the art and is not described in detail here for the sake of brevity of the disclosure.

As shown, in some embodiments, the battery charging circuit 100 may include an AC filter 122 to filter any high order harmonics generated by the AC-to-DC converter 110. The AC filter 122 may correspond to any passive filter circuit consisting of an inductor 116 and a capacitor 118. For example, as shown in FIGS. 1 and 2, the AC filter 122 is an inductor-capacitor-inductor (LCL) filter consisting of inductors 116 and the capacitor 118 connected between the AC source 102 and the AC-to-DC converter 110.

The DC link capacitor 112 is electrically connected to the output terminals 114 of the AC-to-DC converter 110. The DC link capacitor 112 may filter out any ripples in the DC voltage at the output terminals 114 of the AC-to-DC converter 110 and provides a stable DC-link voltage across the DC link capacitor 112. The DC link capacitor 112 may correspond to any energy storage element, such as, a capacitor designed to filter out ripples in the DC voltage derived from the AC input voltage.

The DC-to-DC converter 120 is controlled to output a DC current at a voltage required for charging the battery 104. For example, the DC-to-DC converter 120 is controlled to output the DC current at a voltage varying between 300 Volts to 1500 Volts, depending upon the requirements of the battery 104. To this end, the DC-to-DC converter 120 includes a plurality of transistors 128 for example, six (6) transistors 128, that are controlled to switch between the open state and the closed state to output the DC current at the voltage required by the battery 104. For example, the transistors 128 may correspond to insulated-gate bipolar transistors or any similar transistors known in the art.

For example, the DC-to-DC converter 120 may include three legs 130 with each leg 130 including a high-side transistor 132 connected between a positive terminal (+) of the DC link capacitor 112 and a corresponding output inductor 140 and a low-side transistor 134 connected between the corresponding output inductor 140 and the ground 142. Each of the high-side transistors 132 and the low-side transistors 134 are controlled to switch between the open state and the closed state in an alternate manner to output the DC current at the voltage required by the battery 104. For example, when the high-side transistors 132 are in the closed state, the low-side transistors 134 are controlled to be in the open state and vice-versa. The switching of the high-side transistors 132 and the low-side transistors 134 is controlled by varying a duty cycle of a second pulse width modulation (PWM) signal 138 provided to the high-side transistors 132 and the low-side transistors 134. By varying the duty cycle of the second PWM signal 138 provided to the high-side transistors 132 and the low-side transistors 134, the flow of current through the high-side transistors 132 and the low-side transistors 134 can be controlled, thereby providing the DC current at the voltage required by the battery 104. It would be appreciated that the functioning of the DC-to-DC converter 120 is well known in the art and is not described in detail here for the sake of brevity of the disclosure.

The DC current from the DC-to-DC converter 120 is passed through the output inductors 140. The output inductors 140 corresponds to a storage element that ensures consistent supply of the DC current to the battery 104. The DC current from the output inductors 140 is passed through a DC capacitor 144 that smoothen out and reduces any residual ripple in the voltage provided to the battery 104.

In conventional systems, both power conversion stages (i.e., the AC-to-DC converter 110 and the DC-to-DC converter 120) of the battery charging circuit 100 are operated to provide the DC current at the voltage in the range of 300 Volts to 1500 Volts. However, when the voltage is greater than a predefined threshold, for example, 1100 Volts, the switching losses in the battery charging circuit 100 also increase, thereby resulting in increased power losses. Furthermore, the ripples in the DC current provided to the battery 104 also increase at the voltage greater than the predefined threshold, thereby affecting the health of the battery 104. Moreover, when operating at the voltage greater than the predefined threshold, the duty cycle of the DC-to-DC converter 120 may be increased to meet the high voltage requirements, potentially causing instability in the DC-to-DC converter 120.

To minimize or reduce the power losses, to minimize the ripples in the DC current provided to the battery 104, and to improve stability of the DC-to-DC converter 120, in one or more aspects of the present disclosure, a system 150 for operating the battery charging circuit 100 for charging the battery 104 is described. As shown in FIGS. 1 and 2, the system 150 includes a controller 152 configured to control the battery charging circuit 100 to operate in a first mode to output the DC current at a first voltage less than or equal to the predefined threshold and control the battery charging circuit 100 to operate in a second mode to output the DC current at a second voltage greater than the predefined threshold. For example, the predefined threshold may correspond to 1100 Volts.

In accordance with various embodiments, in the first mode, the controller 152 is configured to control the AC-to-DC converter 110 to convert the AC input voltage into the DC-link voltage. Further, the controller 152 is configured to control the AC-to-DC converter 110 to regulate the DC link voltage across the DC link capacitor 112 and the DC-to-DC converter 120 to output the DC current at the first voltage. For example, the first voltage may correspond to the voltage less than the predefined threshold. It will be appreciated that, in the first mode, the controller 152 controls the AC-to-DC converter 110 and the DC-to-DC converter 120 to perform functions as described in detail above in the forementioned disclosure.

In accordance with various embodiments, in the second mode, the controller 152 is configured to control the AC-to-DC converter 110 to output the DC current. To this end, the controller 152 is configured to adjust the duty cycle of the transistors 124, for example, by adjusting the first PWM signal 136, in the AC-to-DC converter 110 to output the DC current for charging the battery 104. In an exemplary embodiment, the duty cycle is adjusted based on a comparison of the DC current provided by the AC-to-DC converter 110 with a reference value, for example, to match the DC current from the AC-to-DC converter 110 with the reference value. For example, the reference value may correspond to a level of DC current required by the battery 104.

Further, as shown in FIG. 2, in the second mode, the controller 152 is configured to bypass the DC-to-DC converter 120 to equalize the DC link voltage with the second voltage. In accordance with various embodiments, the second voltage corresponds to a voltage level of the battery. To this end, the controller 152 is configured to adjust the duty cycle of the high-side transistors 132 and the low-side transistors 134, for example, by adjusting the second PWM signal 138, to maintain the high-side transistors 132 of the DC-to-DC converter 120 in the closed state (shown in FIG. 2) and the low-side transistors of the DC-to-DC converter 120 in the open state (shown in FIG. 2). By maintaining the high-side transistors 132 in the closed state and the low-side transistors 134 in the open state, the continuous conduction of the DC current from the AC-to-DC converter 110 to the battery 104 is enabled.

In accordance with various embodiments, as the DC-to-DC converter 120 is bypassed, the controller 152 is configured to pass the DC current from the AC-to-DC converter 110 via the DC link capacitor 112 through a combination of the output inductor 140 and the DC capacitor 144. This results in the DC current from the AC-to-DC converter 110 to be rectified via the capacitor-inductor-capacitor (CLC) configuration filter (i.e., the combination of DC link capacitor 112, the output inductor 140, and the DC capacitor 144).

The controller 152 may be one or more processor, a microprocessor, a microcontroller, an electronic control module (ECM), an electronic control unit (ECU), or any other suitable means for controlling the operations of the AC-to-DC converter 110 and the DC-to-DC converter 120. The controller 152 may be implemented using one or more controller technologies, such as Application Specific Integrated Circuit (ASIC), Reduced Instruction Set Computing (RISC) technology, Complex Instruction Set Computing (CISC) technology or any other similar technology now known or developed in the future.

### Industrial Applicability

FIG. 3 describes an exemplary method 300 for operating the battery charging circuit 100 for charging the battery 104. The method 300 includes, at step 302, controlling the battery charging circuit 100 to operate in the first mode to output the DC current at the first voltage less than or equal to the predefined threshold. Further, at step 304, the method 300 includes controlling the battery charging circuit 100 to operate in the second mode to output the DC current at the second voltage greater than the predefined threshold.

The system 150 and the method 300 of the present disclosure control the battery charging circuit 100 to operate in two different modes depending upon the voltage of the battery charging circuit to reduce power losses and ripples in the DC current. By controlling the battery charging circuit 100 to operate in the second mode, the switching losses associated with the switching of the transistors 128 in the DC-to-DC converter 120 becomes negligible thereby reducing the power losses in the system. Moreover, since the voltage at the output terminals 114 of the AC-to-DC converter 110 corresponds to the voltage level of the battery 104 in the second mode (which may be less than 1500V), the switching losses associated with the switching of the transistors 124 are also reduced. Further, the ripples in the DC current provided by the battery charging circuit 100 in the second mode are also reduced, as the high-side transistors 132 of the DC-to-DC converter 120 remain in the closed state. Further, since the DC-to-DC converter 120 is bypassed (i.e., non-operational) in the second mode, the losses associated with the instability of the DC-to-DC converter 120 at higher battery voltage levels are also reduced.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A method of operating a battery charging circuit for charging a battery, the battery charging circuit including an alternating current (AC) to direct current (DC) converter, a DC link capacitor electrically connected to output terminals of the AC-to-DC converter, and a DC-to-DC converter electrically connected across the DC link capacitor, the method comprising:
controlling the battery charging circuit to operate in a first mode to output a DC current at a first voltage less than or equal to a predefined threshold; and
controlling the battery charging circuit to operate in a second mode to output the DC current at a second voltage greater than the predefined threshold, wherein:
in the first mode, the AC-to-DC converter is controlled to regulate a DC link voltage across the DC link capacitor and the DC-to-DC converter is controlled to output the DC current at the first voltage, and
in the second mode, the AC-to-DC converter is controlled to output the DC current and the DC-to-DC converter is bypassed to equalize the DC link voltage with the second voltage, wherein the second voltage corresponds to a voltage level of the battery.

2. The method of claim 1, wherein the DC-to-DC converter includes three legs, each leg including a high-side transistor connected between a positive terminal of the DC link capacitor and a corresponding output inductor, and wherein bypassing the DC-to-DC converter includes maintaining the high-side transistors of the respective three legs in a closed state when the battery charging circuit is operating in the second mode.

3. The method of claim 2, wherein maintaining the high-side transistors of the three legs in the closed state enables conduction of the DC current from the AC-to-DC converter to the battery.

4. The method of claim 2, wherein each leg further includes a low-side transistor connected between the corresponding output inductor and ground, and wherein bypassing the DC-to-DC converter includes maintaining the low-side transistors of the respective three legs in an open state when the battery charging circuit is operating in the second mode.

5. The method of claim 4, wherein the high-side transistors and the low-side transistors of the DC-to-DC converter correspond to insulated-gate bipolar transistors.

6. The method of claim 1, wherein controlling the AC-to-DC converter to output the DC current for charging the battery includes adjusting a duty cycle of a plurality of transistors in the AC-to-DC converter based on a comparison of the DC current with a reference value, wherein the reference value corresponds to a level of DC current required by the battery.

7. The method of claim 6, wherein adjusting the duty cycle of the plurality of transistors in the AC-to-DC converter includes:
adjusting a pulse width modulation (PWM) signal provided to the plurality of transistors in the AC-to-DC converter.

8. The method of claim 1, further including:
in the second mode, rectifying the DC current from the AC-to-DC converter using a capacitor inductor capacitor (CLC) configuration filter.

9. The method of claim 8, wherein bypassing the DC-to-DC converter enables the DC current from the AC-to-DC converter to be rectified via the CLC configuration filter.

10. The method of claim 1, wherein the predefined threshold corresponds to 1100 Volts.

11. A system for operating a battery charging circuit for charging a battery, the battery charging circuit including an alternating current (AC) to direct current (DC) converter, a DC link capacitor electrically connected to output terminals of the AC-to-DC converter, and a DC-to-DC converter electrically connected across the DC link capacitor, the system comprising:
a controller configured to:
control the battery charging circuit to operate in a first mode to output a DC current at a first voltage less than or equal to a predefined threshold; and
control the battery charging circuit to operate in a second mode to output the DC current at a second voltage greater than the predefined threshold, wherein:
in the first mode, the AC-to-DC converter is controlled to regulate a DC link voltage across the DC link capacitor and the DC-to-DC converter is configured to output the DC current at the first voltage, and
in the second mode, the AC-to-DC converter is controlled to output the DC current and the DC-to-DC converter is bypassed to equalize the DC link voltage with the second voltage, wherein the second voltage corresponds to a voltage level of the battery.

12. The system of claim 11, wherein the DC-to-DC converter includes three legs, each leg including a high-side transistor connected between a positive terminal of the DC link capacitor and a corresponding output inductor, and wherein the controller is configured to bypass the DC-to-DC converter by maintaining the high-side transistors of the respective three legs in a closed state when the battery charging circuit is operating in the second mode.

13. The system of claim 12, wherein maintaining the high-side transistors of the three legs in the closed state enables conduction of the DC current from the AC-to-DC converter to the battery.

14. The system of claim 12, wherein each leg further includes a low-side transistor connected between the corresponding output inductor and ground, and wherein the controller is configured to bypass the DC-to-DC converter by maintaining the low-side transistors of the respective three legs in an open state when the battery charging circuit is operating in the second mode.

15. The system of claim 14, wherein the high-side transistors and the low-side transistors of the DC-to-DC converter correspond to insulated-gate bipolar transistors.

16. The system of claim 11, wherein the controller is configured to control the AC-to-DC converter to output the DC current for charging the battery by adjusting a duty cycle of the plurality of transistors in the AC-to-DC converter based on a comparison of the DC current with a reference value, wherein the reference value corresponds to a level of DC current required by the battery.

17. The system of claim 16, wherein the controller is configured to adjust the duty cycle of the plurality of transistors in the AC-to-DC converter by:
adjusting a pulse width modulation (PWM) signal provided to the plurality of transistors in the AC-to-DC converter.

18. The system of claim 11, wherein the controller is further configured to:
control a capacitor inductor capacitor (CLC) configuration filter to rectify the DC current from the AC-to-DC converter in the second mode.

19. The system of claim 18, wherein bypassing the DC-to-DC converter enables the DC current from the AC-to-DC converter to be rectified via the CLC configuration filter.

20. The system of claim 11, wherein the predefined threshold corresponds to 1100 Volts.
